(19) United States
(12) Patent Application Publication
(10) Pub. No.: US 2012/0053895 A1
(43) Pub. Date: Mar. 1, 2012

(54) METHOD AND SYSTEM FOR EVALUATING THE CONDITION OF A COLLECTION OF SIMILAR ELONGATED HOLLOW OBJECTS

(76) Inventors: Noam Amir, Ness-Ziona (IL); Tal Pechter, Ramat-Hasharon (IL); Oded Barzelay, Sha'arei-Tikva (IL); Harel Primack, Rishon-Le-Zion (IL); Silviu Zilberman, Rishon Le-Zion (IL); Shai Silberstein, Ness Ziona (IL)

(21) Appl. No.: 13/205,595

(22) Filed: Aug. 8, 2011

Related U.S. Application Data
(60) Provisional application No. 61/374,636, filed on Aug. 18, 2010.

(51) Int. Cl. G06F 15/00

(52) U.S. Cl. 702/179

(57) ABSTRACT

A tester that evaluates the condition of a plurality of elongated hollow objects by emitting a signal into the objects and measuring the reflected signals at particular sample points, generating a statistically related base signal based on the values at each such sample point and creating an adjusted signal for each measures signal by modifying as a function of the base signal. Analyze the adjusted signals to look for anomalies within each object.

### CROSS-REFERENCE TO RELATED APPLICATIONS

This is a non-provisional application for patent being filed in the United States Patent Office under 35 USC 111 and 37 CFR 1.53(b) and claiming priority under 35 USC 119(e) to the provisional application for patent filed in the United States Patent Office on Aug. 18, 2010, bearing the title of METHOD AND SYSTEM FOR EVALUATING THE CONDITION OF A BUNDLE OF SIMILAR OBJECTS and assigned Ser. No. 61/374,636, which application is incorporated herein by reference in its entirety. This application incorporates by reference the United States patent application that is assigned Ser. No. 11/996,503.

### FIELD OF THE INVENTION

The present disclosure generally relates to Non-Destructive Testing (NDT) systems, and more particularly, the disclosure relates to a system and method for evaluating a condition of a collection of similar elongated hollow objects.

### BACKGROUND OF THE INVENTION

Many different systems comprise one or more bundles of elongated hollow objects for a variety of purposes, such as transmitting fluids, cooling systems, etc. In such systems, the elongated hollow objects can includes structures such as, but not limited to: pipes and tubes. Throughout the description, the terms collection of similar objects or bundle of similar object are used interchangeably and the term bundle of objects can be used as representative term for a collection of objects. A few non-limiting examples of exemplary systems that can incorporate one or more bundles of pipes and tubes can be: heat exchangers, boilers, reactors, air conditioner systems, manifolds, cooling passageways. Such bundles can be found in power stations, refineries, chemical plants, air conditioning systems, etc. Liquid or gas flowing through the tubes may often leave a gradual accumulation of deposits on the inner surface of the tubes creating constrictions along the tubes or pipes. In addition or in lieu, the flow may create wall-loss imperfections such as pitting, rupture, holes, wall-thinning, etc. along the tube walls.

The above-described flaws in a bundled tube delivery mechanism may cause problems. Problems such as, but not limited to: degrade the efficiency of the bundle of tubes, increase the power consumption, cause a rupture, degrade the overall system performance; etc. Therefore it is common practice to test and evaluate the condition of the tubes and especially its surfaces periodically. There are a few known methods and systems for examining and evaluating which tubes (pipes) need to be cleaned, replaced, plugged, or fixed. Some of the methods and systems can be implemented by Non-Destructive Testing (NDT) such as, but not limited to: Acoustic Pulse Reflectometry (APR), visual methods using borescope, methods using eddy current, ultra sound inspection, etc.

It should be noted that the terms “problem”, “defect” and “flaw” may be used interchangeably herein. Henceforth, the description of the embodiments of the present disclosure may use the term “flaw” as a representative term.

APR is a generic name given to a family of systems and methods used to measure an acoustic response of a given elongated hollow object. The term APR is derived from the fact that an acoustic excitation pulse (input signal) is applied to an elongated hollow object being tested, and the reflections (acoustic response) created by the elongated hollow object are measured and analyzed.

Various algorithms are applied to the received and measured acoustic response of an elongated hollow object in order to gain information regarding the elongated hollow object being examined. Information such as, but not limited to: the inner structure/geometry of the system under test, unwanted changes in the elongated hollow object, and the location of the changes in the elongated hollow objects. Changes such as but not limited to, unwanted blockage in the system; unwanted holes; wall-loss such as pitting, erosion; internal deformations; etc.

A reader who wishes to learn more about APR is invited to access the AcousticEye web site at the following URL: www<dot>acousticeye<dot>com, for example, the content of which is incorporate herein by reference. Additional information regarding APR NDT system on tubular elongated hollow objects can be found in United States patent application assigned Ser. No. 11/996,503 the content of which is incorporate herein by reference above in the cross-reference section.

### SUMMARY OF THE DESCRIPTION

Heat exchangers, boilers, reactors, air conditioner systems, manifolds, cooling passageways, as well as other systems employ the use of elongated hollow objects to delivery liquid and gasses to various locations within the system for varying purposes. As described in the background, it is important to conduct periodic evaluation measurement tests on such elongated hollow objects to ensure proper operation of such systems. The evaluation tests may detect different deformations and/or accumulated obstacles and/or wall-loss that may be present within an elongated hollow object. Thus, the evaluation tests can identify problem areas and allow the application of remedial measures to correct or address such problems to hopefully prevent the elongated hollow object's future failures, ruptures, flaw, reduced efficiency, etc.

Prior to performing a measurement on an elongated hollow object for evaluation, it is a common to perform an adjustment or calibration procedure of the measurement-device in relationship to the current conditions of the measuring process. The adjustment procedure allows for the establishment of a baseline or a reference, from which the measurement results may be evaluated, for example. When creating a baseline, the influence of the measuring system as well as the ambient conditions on the measuring results may be taken into account.

As a non-limiting example, some of the influences that may have an effect on the measuring results can include, but are not limited to: variations in the measuring equipment, artificial reflection due to the interface of the measuring device with the elongated hollow object under test, etc. Other exemplary influences may be: acoustic noises along the bundle, vibration and environmental conditions such as, but not limited to, ambient effects, temperature, humidity, etc. The effects along the elongated hollow objects imposed by such influences may vary at different locations within the elongated hollow object. For example, the temperature at the ingress of the elongated hollow object can differ from the temperature at the middle of the object. Likewise, unwanted vibration can be local vibration that varies in magnitude and/or frequency along the course of the elongated hollow object etc. Thus, the adjustment procedure needs to refer to a plurality of points, locations, along the entire length of the object.

The adjustment procedure may be time consuming and expensive. In some cases, the adjustment procedure may actually require more time to perform than the time it takes to measure the plurality of elongated hollow objects. Thus, the long duration of adjustment may discourage a client from having a technician arrive and perform measurement on his/her bundle of elongated hollow objects. In some cases, when performing an evaluation test, a system under testing is required to be shut down, causing loss of income to the client. Furthermore a technician or engineer arriving to evaluate a bundle of elongated hollow objects may charge the client for the time required in performing the adjustments as well as taking the measurements and evaluating the data. In addition, some of the adjustment procedures may require additional equipment (which could be complicated to obtain or expensive to purchase or lease) as well as require special skills or computation knowledge on the part of the testing and/or evaluating entity.

Some known adjustment techniques use a “flawless” (sometimes also termed “pristine”) elongated hollow object to act as a reference object to a measurement done on a similar elongated hollow object. But in practice, it can be somewhat difficult to actually obtain a similar flawless elongated hollow object for such comparison measurements. Thus an accurate adjustment cannot be made. Furthermore, even in situations in which a flawless elongated hollow object is accessible, and a baseline is created based on the flawless elongated hollow object, not all deviations from that baseline indicate flaws of the measured device, for example. Furthermore, if an adjustment procedure is done in a none correct manner or carelessly (a wrong baseline is defined for example) then the analysis of the measurement results, based on the inaccurate baseline, will most likely also be wrong. Further, it can be appreciated that “flawless” elongated hollow object may not accurately represent the local effects along the real bundle of objects due to influences such as temperature, vibrations, structural deformations, etc. because for at least the reason that the flawless elongated hollow object may not exist in the same environmental conditions as the object under test.

It should be appreciated that the above-described deficiencies do not limit the scope of the inventive concepts in any manner but rather, the identified deficiencies are merely presented for illustrating one exemplary situation in which testing may occur.

Exemplary embodiments of the present disclosure present functions, aspects and details of novel systems and methods for measuring a bundle of similar elongated hollow objects and getting adjusted or normalized results without the need of having to perform a common adjustment or calibration procedure prior to the measurements. For example, the new adjusted or normalized results may effectively overcome the influence of the environmental conditions and/or the current condition of the measuring process. Exemplary embodiments of the novel systems and methods may process the measurement results from the bundle of similar elongated hollow objects (e.g. a few tens of elongated hollow objects, such as 30 elongated hollow objects, for example) after the measurements have been made.

The measurement results obtained from the various embodiments may be presented in a variety of forms, such as a graph. In an exemplary graph, points along the ‘X’ axis of the graph may represent locations along the length of the elongated hollow object, in sampling units, along the length axis of the elongated hollow objects being measured. The sampling units may be a function of the sampling rate of the APR system and the speed of sound in the elongated hollow object, for example. The ‘Y’ axis of the graph may represent the amplitude of the measured reflections caused by an APR system, for example. Typically, the points of the y-axis at the positive side represent the beginning of a blockage (narrowing the internal cross section of the pipe) and the points of the y-axis at the negative side represent the beginning of a wall-loss (enlarging the internal cross section of the pipe).

Exemplary embodiments of the novel system and method may operate to calculate a calculated-ensemble function on the plurality of measured results (measured reflections along the inner surface of the elongated hollow objects tested, for example). In an exemplary embodiment, the calculated-ensemble function may be an ensemble average; in another embodiment an ensemble median can be implemented on the measurement results; for example. The calculated-ensemble function may be calculated per each sampling point along the elongated hollow objects length and may be presented in a table or in a graph, for example. The calculated-ensemble function may be used as a baseline of the measuring results. A “sleeve” associated with the calculated-ensemble function may be defined. The width of the sleeve may be a predefined number of deviation factors around the calculated-ensemble function, for example.

In some embodiments, in which the measured bundle comprises a large number of elongated hollow objects (e.g. a few tens to a few thousands of objects), the bundle can be divided into a few groups of objects. In such embodiments, each group can comprise a plurality of objects from the bundle. Dividing the bundle into groups may improve the sensitivity of the process to the location of the object in the bundle of objects. In such embodiments, each group will have its baseline and sleeve.

The sleeve may be presented on the graph as well. The sleeve may be a sleeve surrounding a certain “Y” value, “Y”=zero for example. The sleeve's width may reflect the noisy, uncertainty zone of the measuring values. Reasons for such a zone can be variation of the measuring equipment; artificial reflection due to the interface association of the measuring equipment with the elongated hollow objects, variability of the measuring process, etc. The sleeve's width may vary along the different sampling points. Results that are located within the sleeve can be ignored as noise. More information regarding the measurements and the relationship of sleeves are disclosed below in conjunction with FIGS. 3A-3D.

The calculated-ensemble function, as a baseline, and the sleeve can replace the common pre-measurement-adjustment or calibration process that is required in the prior art. Measurement results situated inside the sleeve may be considered as normal variability of the measuring process and may represent flawless areas along the hollow elongated hollow object.

For each sampling point of each measured elongated hollow object, exemplary embodiments of the novel system and method may subtract from the measured results, the result of the calculated-ensemble function at that sampling point along the length of the elongated hollow objects, thus creating adjusted results.

A measurement report document representing the adjusted results can be created without the need to conduct an adjustment procedure prior to conducting the test measurements.

Yet in other embodiments, the calculated-ensemble function can be implemented for each object by comparing the measurements for each object to the measurement results for each one of the other objects in the bundle or in the group of objects. An exemplary calculated ensemble function can be implemented on a plurality of the differences of the measured results, along the object, received from the object compared to the measured result of each one of the other objects in the bundle or in the group of bundles. The calculated-ensemble function for each elongated hollow object may be presented in a table or in a graph of points along the object. In such embodiments, for each object, the calculated-ensemble function for the object may present the adjusted result of the object.

Exemplary embodiments of the present disclosure may also calculate, and/or simulate, reflections from various types of flaws that may be found along the internal surface of a representative elongated hollow object for measured elongated hollow objects, for example. The simulation of the reflections from different flaws takes into consideration the influence of the interface between the measuring system and the elongated hollow object under test on the reflected signal from the simulated flaw.

The calculation/simulation may be based on different parameters of a representative elongated hollow object of the elongated hollow objects in the bundle of similar elongated hollow objects. Exemplary parameters of such a representative elongated hollow object may be: the diameter of the elongated hollow object being measured, the thickness of elongated hollow object's walls, the structure of the interface of the elongated hollow object, the structure of the interface of the measuring device, and so on. Simulation of reflections due to various types of flaws that may be found in the measured elongated hollow objects, the transmission function of various types of flaws, as well as simulation of the interface of the measuring equipment, and reflections due to the connection of the measuring equipment to an elongated hollow object, in an APR system for example, is well known to a skilled person in the art and is described in technical books.

Based on the simulation, exemplary embodiments of the present disclosure may further prepare a plurality of tables and/or graphs. The tables and/or graphs can include, but are not limited to: a threshold-value table and/or graph.

For each measured elongated hollow object, at each sampling point along that elongated hollow object having an adjusted result, which is bigger than the sleeve, the adjusted result may be compared to the set of the calculated threshold values in order to determine the amplitude of a potential flaw in that sampling point. From the comparison to the threshold-values a conclusion regarding which flaws exist in the elongated hollow object can be deduced. Furthermore the presently disclosed methods and systems enable the identification of the location of the flaws along the inside of the elongated hollow object.

The foregoing summary is not intended to summarize each potential embodiment or every aspect of the present invention, and other features and advantages of the present invention will become apparent upon reading the following detailed description of the exemplary embodiments with the accompanying drawings and appended claims.

Furthermore, although specific exemplary embodiments are described in detail to illustrate the inventive concepts to a person skilled in the art, such embodiments can be modified to various modifications and alternative forms. Accordingly, the figures and written description are not intended to limit the scope of the inventive concepts in any manner.

### BRIEF DESCRIPTION OF THE DRAWINGS

Exemplary embodiments of the present disclosure will be understood and appreciated more fully from the following detailed description, taken in conjunction with the drawings in which:

FIG. 1A and FIG. 1B depict an exemplary portion of common systems that comprise one or more bundles, each bundle comprising a plurality of similar elongated hollow objects, in which an exemplary embodiment of the present disclosure may be used;

FIG. 2 depicts a simplified block diagram with relevant elements of an exemplary measurement setup in which an exemplary embodiment of the present disclosure may be used;

FIG. 3A depicts exemplary measurement results on which an exemplary embodiment of the present disclosure may be used;

FIG. 3B, FIG. 3C and FIG. 3D depict exemplary processed measurement results according to exemplary embodiment of system and method of the present disclosure;

FIG. 4 schematically illustrates a flowchart showing relevant acts of an exemplary embodiment of a method for calculating a baseline (a reference) of the measured bundle of similar elongated hollow objects;

FIG. 5 schematically illustrate a flowchart showing relevant acts of an exemplary embodiment of a method for identifying type and location of one or more flaws in a measured elongated hollow object from a plurality of similar elongated hollow objects, according to exemplary the teaching of the present disclosure; and

FIG. 6 is a functional block diagram of the components of an exemplary embodiment of platform that can be used for implementing various embodiments or aspects of various embodiments.

It is noted that the figures are for illustration purposes only and are not necessarily drawn to scale and the illustrated order and relationships of various actions and/or components are provided only as an exemplary embodiment and other variations are also anticipated.

### DETAILED DESCRIPTION OF EXEMPLARY EMBODIMENTS

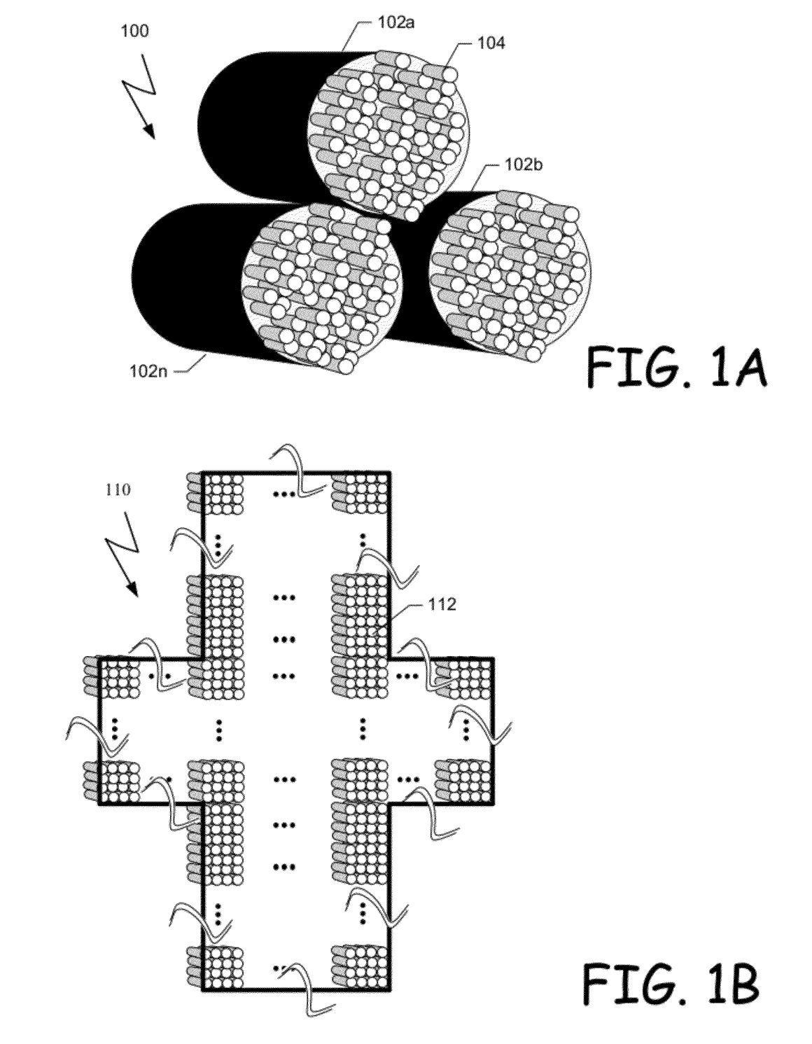

FIG. 1A depicts an exemplary portion of a common system 100 that comprises a plurality of bundles 102a-n of similar elongated hollow objects 104. In FIG. 1A, the exemplary similar elongated hollow objects under test are tubes (pipes) 104. The plurality of tubes (pipes) 104 may be stacked together in a bundle 102. The tubes 104 may be very close to one another, only a few millimeters apart. In an alternate embodiment, there may be a different number of tubes 104 in each bundle 102. The size of the bundles 102 may differ from one another. The number of tubes 104 in each bundle 102 may also be different.

FIG. 1B depicts another exemplary bundle of pipes (tubes) of a heat exchanger 110, for example. The heat exchanger 110 may comprise a plurality of tubes 112 arranged in a cross shape, for example.

It should be noted that the elongated hollow objects under test may be other than tubes, meaning they are not restricted to tubes (pipes) alone. It should also be noted that the terms “tube”, “pipe” and “elongated hollow object” may be used interchangeably herein. Henceforth, the description of the embodiments of the present disclosure may use the term “elongated hollow object” as a representative term for an “elongated hollow object inside a bundle of similar elongated hollow objects”.

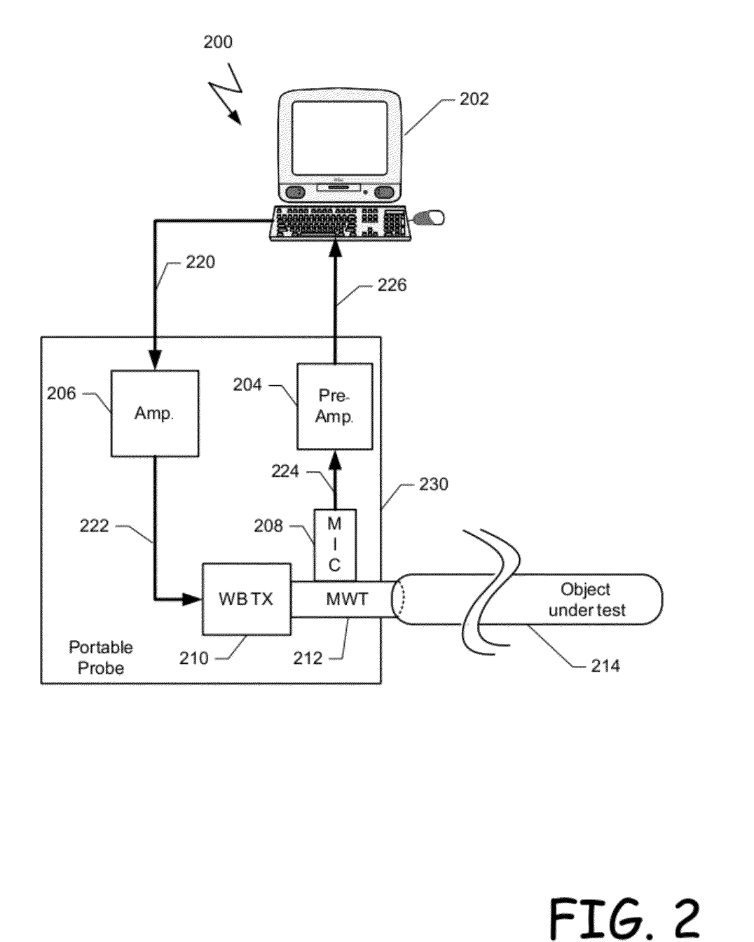

FIG. 2 depicts a simplified block diagram with relevant elements of an exemplary measurement system 200 in which an exemplary embodiment of the present disclosure may be used. An exemplary measurement system 200 may be a Non-Destructive Testing (NDT) system such as, but not limited to, an Acoustic Pulse Reflectometry (APR) system. Exemplary embodiments of an APR system 200 may include: a computer 202 with a data acquisition card (DAQ); and a portable probe 230. The portable probe 230 may comprise a pre-amplifier 204 with an optional automatic gain control (not shown); an amplifier 206 with an optional automatic-gain control (not shown); a pressure sensor (also referred to in the art as “microphone” or (“receiver”) 208; a wide band signal transmitter (WBTX) 210 (also referred to in the art as “transducer” or “loudspeaker”) and a mixed wave tube (MWT) 212. In one embodiment, the pre-amplifier 204, the amplifier 206, the pressure sensor 208, the wide band signal transmitter 210 and the mixed wave tube (MWT) 212 can be assembled into the portable probe 230. The portable probe 230 can communicate with the computer 202 via wired or wireless connections. In some embodiments the amplifier 206 and/or the preamplifier 204 may be embedded in the computer 202 or in an intermediate box and not in the portable probe.

The term “mixed wave tube” as used herein means a tube in which signals propagating therein rightward and leftward overlap at the sensor 208. The mixed tube may be connected to one of the elongated hollow objects under test 214 from the plurality of elongated hollow object being tested. The Computer 202 may generate an excitation signal. The excitation signal may be output toward the amplifier 206 through a link 220, for example. The amplifier 206 may amplify the received signal and transfer it toward the wide band transmitter 210 via link 222.

The wide band transmitter 210 may convert the received amplified signal to acoustic waves and transmit the acoustic waves toward the mixed-wave tube 212. The transmitted acoustic waves can pass through the mixed wave tube 212 and the elongated hollow object 214 under test. Reflections due to the elongated hollow object under test 214, the flaws and the interface with the mixed wave tube 212 may be reflected back.

The sensor 208 may receive the reflected acoustic waves arriving at the mixed wave tube 212. Sensor 208 may convert the received reflected acoustic waves into electrical signals and transfer the electrical signals toward the pre amplifier 204 via link 224, for example. The pre amplifier 204 may amplify the received electrical signals and send them toward the data acquisition card (not shown) in the computer 202, via link 226. The amplified electrical signal may be sampled by the data acquisition card and recorded in the computer 202. A reader who wishes to learn more about Acoustic Pulse Reflectometry (APR) is invited to visit the AcousticEye web site at the following URL: www<dot>acousticeye<dot>com, for example, the content of which is incorporate herein by reference. Additional information regarding APR non-destructive testing system on tubular elongated hollow objects can be found in the United States patent application assigned Ser. No. 11/996,503 the content of which is incorporate herein by reference above in the cross-reference to related applications section. Exemplary embodiments of the present disclosure enable obtaining measurements on a plurality of elongated hollow objects without the need to adjust the measuring equipment with the elongated hollow objects under test 214 and taking into consideration the current environmental conditions in which the bundle exists and along the elongated objects of the bundle. More information is disclosed in conjunction with the remaining figures.

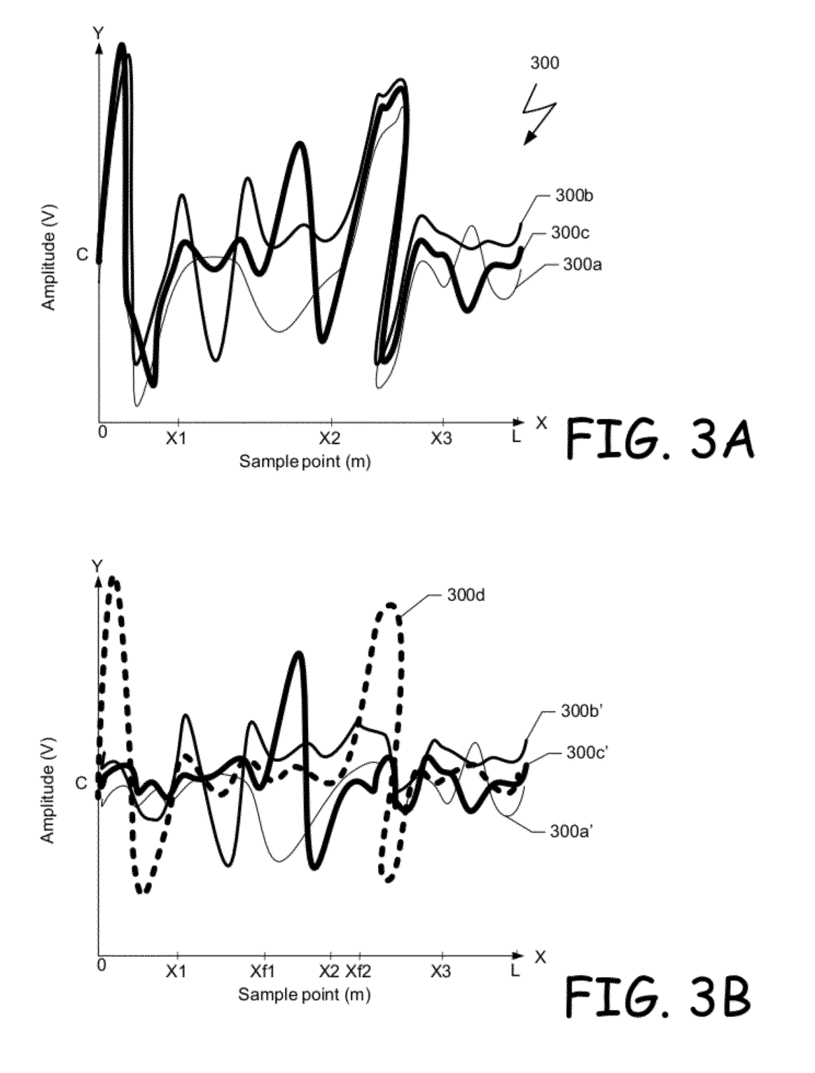

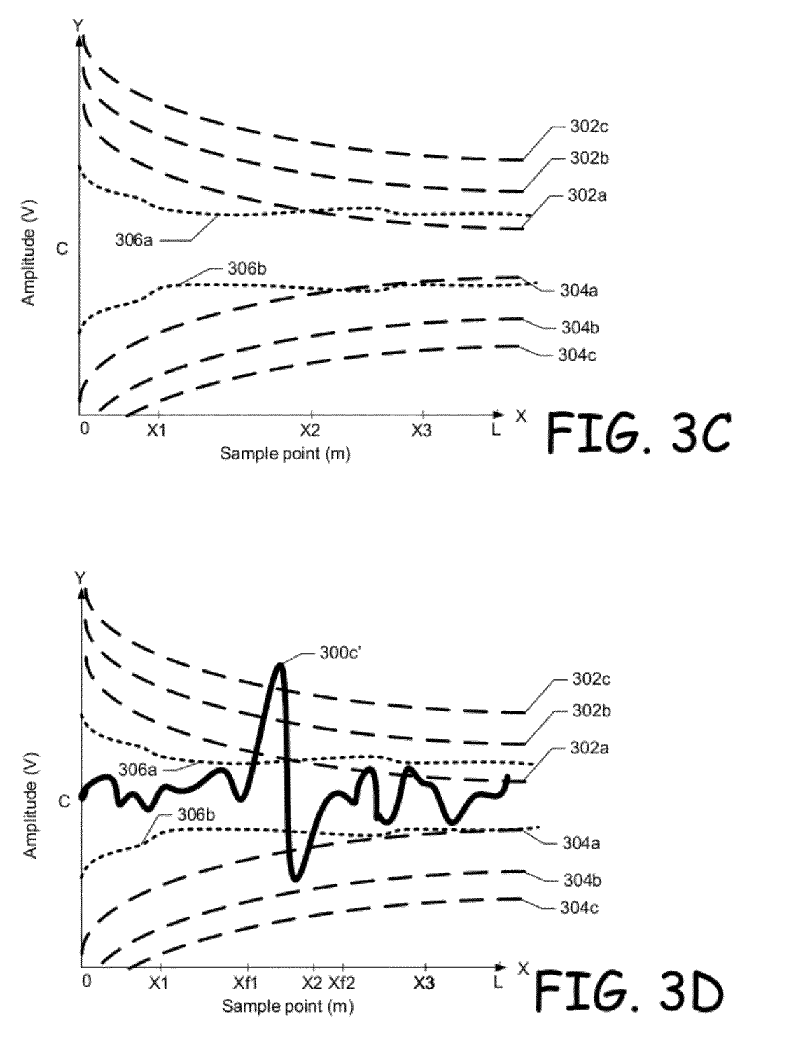

FIG. 3A is a graph illustrating the measured amplitude of reflected acoustic signals for several elongated hollow objects. The waves depicted in FIG. 3 represent exemplary measurement results 300 of a plurality of elongated hollow objects on which an exemplary embodiment of the present disclosure may be implemented. The measurement results 300 may represent results of measurements in which the measuring equipment has not been adjusted to the current conditions of the measurements, for example. For simplicity reasons, only measurement results from three elongated hollow objects from the plurality of elongated hollow objects are depicted by curves 300a, 300b and 300c. Each measurement result is depicted in a different curve (line) width. It should be noted that there may be more measurement results from additional elongated hollow objects. Each curve may represent measurement results of a different elongated hollow object under test along the object. The X-axis may represent the sampling points of the receiving signal from the MIC 208 (FIG. 2), along the elongated hollow objects under test. In some embodiments the sampling point can be converted to units such as meters, centimeters or inches, or percentages of the total length of the object. The Y-axis may represent the amplitude of the measured reflections. For example, the units in the Y-axis may be represented in volts of the converted received electrical signal. The measured results of each object reflects also the effect of the current ambient conditions such as but not limited to temperature, humidity, acoustic noise, interfaces, etc, on the reflection received from each point along measured object. The measurement results 300 of all the objects may be around a certain Y value, zero for example.

In the example of FIG. 3A, four zones along the pipe ('X′ axis) can be observed. The first zone, wherein ‘X’ is in the range of approximately 0≦X≦X1, the second zone wherein ‘X’ is in the range of X1≦X≦x2, the third zone wherein ‘X’ is in the range of approximately X2≦X≦X3 and the fourth zone in which X3≦X≦L, where L is the length of the elongated hollow object that is being tested. In the first and the third zones of this example, the three curves approximately follows each other. While in the other two zones, zones two and four, the three curves behave in substantially different ways. The sample points along the length of the elongated hollow objects are determined based on the timing of the samples. In typical operation, an elongated hollow object is analyzed by emitting a signal into the opening of the elongated hollow object and then listening for reflections. However, if the process simply listens for reflections, then insufficient data is acquired to provide the adjusted calculations as presented herein. As such, after the initial signal is emitted, the system operates by sampling the reflected signal at various points in time, t1, t1, t3 . . . tn. Thus, knowing the propagation timing of the originally emitted signal, the sampling times then equate to physical locations along the elongated hollow object in that at sample t1, any reflections that would be received from point X1 would be mesasureable.

FIG. 3B illustrates an ensemble average curve 300d of the plurality of measured elongated hollow objects including the elongated hollow objects associated with the exemplary curves 300a, 300b and 300c. The ensemble average curve 300d can be used as a reference, a baseline for the measurements of the plurality of similar elongated hollow objects. In the X zones of X1≦X≦X2 and X3≦X≦L of this example, the ensemble curve 300d has a small amplitude and fluctuates around the value Y=C, exemplary C can be zero. While in the first and the third X zones, 0≦X≦X1 and X2≦X≦X3, of this example, the ensemble average 300d has a substantially high amplitude. These zones include reflections which can be related to the structure of the measuring system and the interface of the measuring device with each elongated hollow object under test and/or to the structure of the pipes in the bundle. The measurements in the first zone, 0≦X≦X1 can reflect the interface while the measurements in the third zone, X2≦X≦X3 can reflect the structure of the objects in the bundle, for example. An exemplary ensemble function can be ensemble median that can be calculated per each sampling point. In such embodiment curve 300d may represent the ensemble median as the baseline.

In other embodiments, a calculated-ensemble function can be implemented for each object by comparing each object to each of the other objects that are included within the bundle. An exemplary calculated-ensemble function for each of the objects can be implemented based at least in part on the plurality of the differences of the measured results along the object, received from the object compared to the measured results of each one of the other objects in the bundle. The calculated-ensemble function for each elongated hollow object may be presented in a table or in a graph of points along the object. In such embodiments, an exemplary ensemble function can be calculated per each object, as the average of the differences of that object compare to the others. The calculated-ensemble function for the object may represent the adjusted result of the object.

In another embodiment, in which the measured bundle comprises a large number of elongated hollow objects (i.e, from a few tens to a few thousands of objects), the bundle can be divided into a few groups. For the bundle of FIG. 1A, each sub-bundle 102a-c can be referred as a group. Each group can comprise a plurality of objects from the bundle. Dividing the bundle into groups may improve the sensitivity of the process to the location of the object in the bundle of objects. The ensemble function can be implemented on each one of the groups and each group can be referred to as independent bundle.

In addition FIG. 3B illustrates three other curves 300a′, 300b′ and 300c′ which represent the curves 300a, 300b and 300c of FIG. 3B, after being adjusted or normalized based on the calculated-ensemble curve 300d. Curve 300d may not be presented to a user during the measuring process. It is illustrated in FIG. 3B just for better understanding of the process. Curve 300a′ represents the adjusted result and is calculated by subtracting the average value (300d) from the measured value (300a) at each of the sampling points along the curves 300d and 300a. In a similar fashion, curve 300b′ and curve 300c′ are calculated and drawn by using the results of curves 300b and 300c respectively. Curve 300a′, 300b′ and 300c′, in most of the sampling points, fluctuate around the value Y=C. Areas in which the value of the reflections in one of the curves is significantly other than C, above or below C, may be suspected as flaws in the relevant pipe. The direction of the curve can indicate the type of the flaw, a wall-loss or a blockage.

By examining the curve 300c′ in the range in which Xf1≦X≦Xf2, it is clear that the reflection at each sampling point after Xf1 is continuously increasing above the value of Y=C. After a certain sampling point (the maximum point) the curve starts decaying down until a minimum point is reached. From this minimum point until the point X=Xf2 the value of Y is increased and approaches the value of Y=C. Such behavior of the reflection indicates that there is a blockage, for example. A blockage can be represented by a local maximum, pointing the beginning of the blockage, followed by a local minimum at the end of the blockage. A wall-loss can be represented by a local minimum, pointing the beginning of the anomaly, followed by a local maximum at the end of the wall-loss.

FIG. 3C depicts a next act in the process in which a sleeve dotted curves 306a and 306b is added around the Y=0 at each sampling point, along the X axis. The width of the sleeve can represent a deviation value of the measured reflection values of the plurality of pipes (elongated hollow objects) from the ensemble average value at that sampling point, for example. Areas along the elongated hollow objects in which the reflections' amplitudes fall in the sleeve can be referred to as flawless areas. In an exemplary embodiment, the calculated-ensemble function may be an ensemble average of the measured results, for example. Different types of mathematical functions may be used to construct the sleeve 306a and 306b, an ensemble standard deviation, for example.

Next a plurality of striped curves 302a-c and 304a-c are added. The striped curves 302a-c and 304a-c may be used as threshold values or scale for identifying flaws and their sizes along a theoretical elongated hollow object having a similar structure as the elongated hollow objects of the bundle, for example. Each striped curves 302a-c and 304a-c may represent a simulation of reflections from a certain type of flow in a certain size along the length of the object. Therefore, the curves can be used as a scale for estimating the size and type of the flaws, for example. A blockage can be represented by a pair of local consecutive extrema, a local maximum, at the beginning of the blockage, followed by local minimum at the end of the blockage. A wall-loss can be represented by a pair of local consecutive extrema, a local minimum, at the beginning of the wall-loss, followed by a local maximum at the end of the wall-loss. The absolute value of the amplitude of the first local extremum of a pair can reflect the size of the flaw. The distance between the two local consecutive extrema points of a pair can reflect the length of the flaw. The absolute value of the maximum or minimum can be estimated from the nearest striped curve 302a-c or 304a-c at the points of the maximum or minimum respectively.

The simulated reflection can be location dependent and may have a different amplitude along the length of the elongated hollow object under test. The simulated reflection's amplitude may be considered as a threshold-value table/graph for estimating the size of a flaw in a certain location, for example. Areas of the simulation curves that are located in the sleeve 306a-b can be ignored. Simulation of reflections due to various types of flaws that may be found in the measured elongated hollow objects, as well as simulation of the interface of the portable probe with an elongated hollow object, in an APR system for example, can based on well known foundation of APR system, which are described in technical articles. Following are few exemplary articles that describe the foundation of APR system: “A discrete model for tubular acoustic systems with varying cross section—the direct and inverse problems. Part 1: theory”, or “A discrete model for tubular acoustic systems with varying cross sections—the direct and inverse problems. Part 2: experiments” by N. Amir, G. Rosenhouse, U. Shimony and were published in Acustica, Vol. 81, No. 5, pp. 450-462, 1, or “Losses in tubular acoustic systems—theory and experiment” by N. Amir, G. Rosenhouse, U. Shimony and was published in Acustica, Vol. 82, No. 1, pp. 1-8, 1996.

The threshold values may be prepared or obtained from a threshold-value table, for example. Each of the upper striped curves 302a-c may represent a different blockage size in the measured elongated hollow object along the elongated hollow objects length, for example. Each of the lower striped curves 304a-c may represent a different wall-loss size in the measured elongated hollow object, along the elongated hollow objects length for example.

FIG. 3D illustrates how to implement the exemplary method in preparing the report on the elongated hollow object that is associated with the results of curve 300c (FIG. 3A). In the example of using an ensemble average, first, the ensemble average is subtracted from the values of curve 300c in order to get the curve 300c′ (FIG. 3B) that represent the adjusted results of the object. Next, the curve 300c′ is placed over the calculated sleeve 306a and 306b and the threshold curves 302a-c and 304a-c; the result is illustrated in FIG. 3D. Analyzing the reflection between Xf1 and Xf2, in which the value of the reflection is significantly higher than the sleeve, can lead to a conclusion that a blockage exists in the relevant pipe in the location between Xf1 and Xf2. The size of the blockage is bigger than the size that is represented by curve 302c. In some exemplary embodiments, interpolation can be used for defining the size of the blockage if it falls between threshold curves. For instances, in embodiments in which the Xf1, or Xf2 falls in between sampling points, interpolation can be used. In some exemplary embodiments, tables with values at each of the sampling points can be used instead of the curves. In other embodiments, the values from the tables can be used for drawing the curves of FIG. 3A-D. The size of the flaw can be presented in millimeters (mm), for example, in other embodiments it can be presented in percentages of the diameter of the elongated hollow object, percentages of wall thickness, or percentages of cross section, etc.

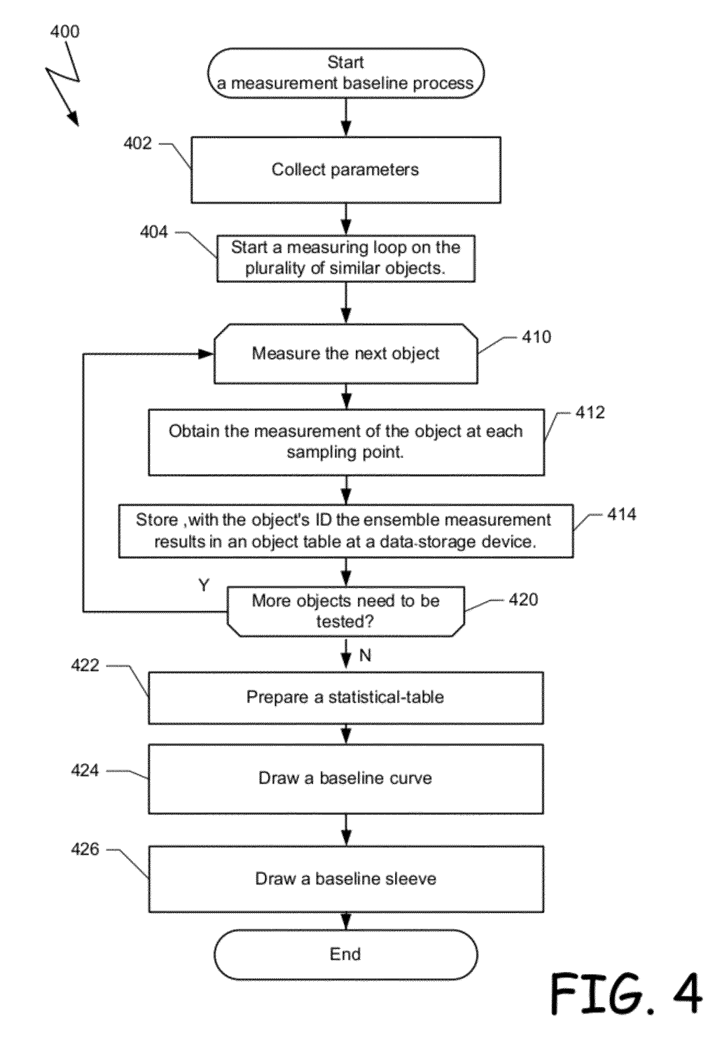

FIG. 4 schematically illustrates a flowchart showing relevant acts of an exemplary embodiment of method 400. Method 400 can be used as a process for adjusting the results obtained by measuring a plurality of similar elongated hollow objects to the current conditions of the measuring process. Method 400 can be implemented by one or more processors of computer 202 (FIG. 2) running instructions stored on a non-transitory memory storage device of computer 202, for example. The plurality of similar elongated hollow objects can be a bundle of similar pipes for example. An exemplary measuring system can be the APR system of FIG. 2. The current conditions of the measuring process may comprise interface affects between the portable probe and the elongated hollow object under test, the structure of the objects, local audio noise or vibrations, ambient conditions, etc. At initiation of method 400, a plurality of different parameters may be collected 402 by prompting a tester to enter those parameters or retrieving the parameters from a system, database, control/measurement devices or the like. A few non-limiting examples of the parameters may include: the diameter of the elongated hollow objects to be tested 214 (FIG. 2), the diameter of the mixed wave tube 212 (FIG. 2), the width of the elongated hollow object's wall 214 (FIG. 2), the width of the mixed wave tube's 212 wall, the number of elongated hollow objects to be tested, etc. The temperature and humidity may also be collected and used in the process for converting the sampling point into metric values.

Next a measuring loop is entered 404, shown as the illustrated actions including and existing between acts 410 and 420. The measuring loop operates by taking measurements and storing results for the plurality of similar elongated hollow objects. The measurements may be done by a human tester, a processor running in a machine, control/sensor devices, a combination of any of these, as well as other configurations for example. The number of similar elongated hollow objects to be tested may be more than a few tens of objects, (i.e. 30 elongated hollow objects or more for example). At act 410 the next elongated hollow object to be tested may be measured 410. As such, an acoustic signal is provided to the opening of the elongated hollow option and the reflections from the current elongated hollow object are collected by the microphone 208 and transferred to the computer 202 (FIG. 2). The reflections, which are audio signals, are sampled and processed 412 into digital data that reflects the amplitude of the received reflected signal along the length of the elongated hollow object at each sampling point. The obtained measurement results may be stored 414 together with the elongated hollow object's ID, for example. The measurement and the ID may be stored in a storage device associated with the computer 202 (FIG. 2).

The stored data can be organized in tables and each table can be associated with an elongated hollow object ID. The table can be referred as an elongated hollow object-table. Each elongated hollow object-table can have a plurality of entries (rows), and each entry can be associated with a sampling point. Each entry can have a plurality of fields (columns) and each column can be associated with a result from a certain measurement or calculation at that sampling point. The first field can be associated with the raw data, the digitized measured amplitude of the reflected signal in each sampling point. Next, a decision needs to be made, whether 420 more elongated hollow objects are needed to be measured. If 420 additional objects need to be measured, then method 400 may return to act 410. If 420 no additional objects need to be tested, then method 400 may proceed to act 422.

Calculated-ensemble functions can be implemented on the data stored in the plurality of elongated hollow object-tables that are associated with the measured elongated hollow objects for preparing a statistical table 422. An exemplary calculated-ensemble function may be an ensemble average, for example. Other embodiments may use an ensemble median, for example. The calculated-ensemble function can be stored in the statistical table. The statistical table can have a plurality of entries with each entry being associated with a sampling point. Further, each entry can have a plurality of fields. As a non-limiting example, a first field can be associated with the ensemble average. The ensemble average can be calculated for each entry (sampling point) as the average of the measured data stored in the plurality of elongated hollow object-tables at the relevant sampling point. The calculated-ensemble function can be referred as a baseline. A second field of the statistical table can be associated with a deviation value at each sampling point. For each point, the standard deviation value of the store data from the average value of the sampling point can be calculated and be stored in the second field as a deviation value, for example. Other embodiments may use other statistical functions, median for example.

Yet, in other embodiments, in which each elongated hollow object is first compared to the plurality of objects and then for each object, an ensemble function is calculated based on the differences from the other objects, a plurality of statistical table can be used (i.e. one statistical table for each object).

In some exemplary embodiments, the information stored in the statistical table can be used for drawing a baseline curve 424 that reflects the ensemble average stored in the first field. The X-axis of the baseline curve represent the sampling points. An exemplary ensemble average curve is represented as curve 300d (FIG. 3B). The Y-axis of the baseline graph may reflect the average value of the reflection amplitude at that sampling point. The baseline curve can fluctuate around a certain value of Y (i.e. C). An exemplary value of C could be zero. In some embodiments, a sleeve can be drawn 426 around the value C. An exemplary sleeve can be the area between the two curves 306a and 306b (FIG. 3C). The sleeve's width may vary along the different sampling points. The defined width of the sleeve can reflect the deviation from the calculated-ensemble function of the measuring at each sampling point. At each sampling point, the width of the sleeve can be equal to multiples of the standard deviation value stored in the second field of the statistical table (i.e, 2 to 6 times the value for example). The width value of the sleeve at each sampling point can be stored in the third field of the statistical table. The sleeve around the Y=C point may be marked 426 on the base graph, and method 400 may end.

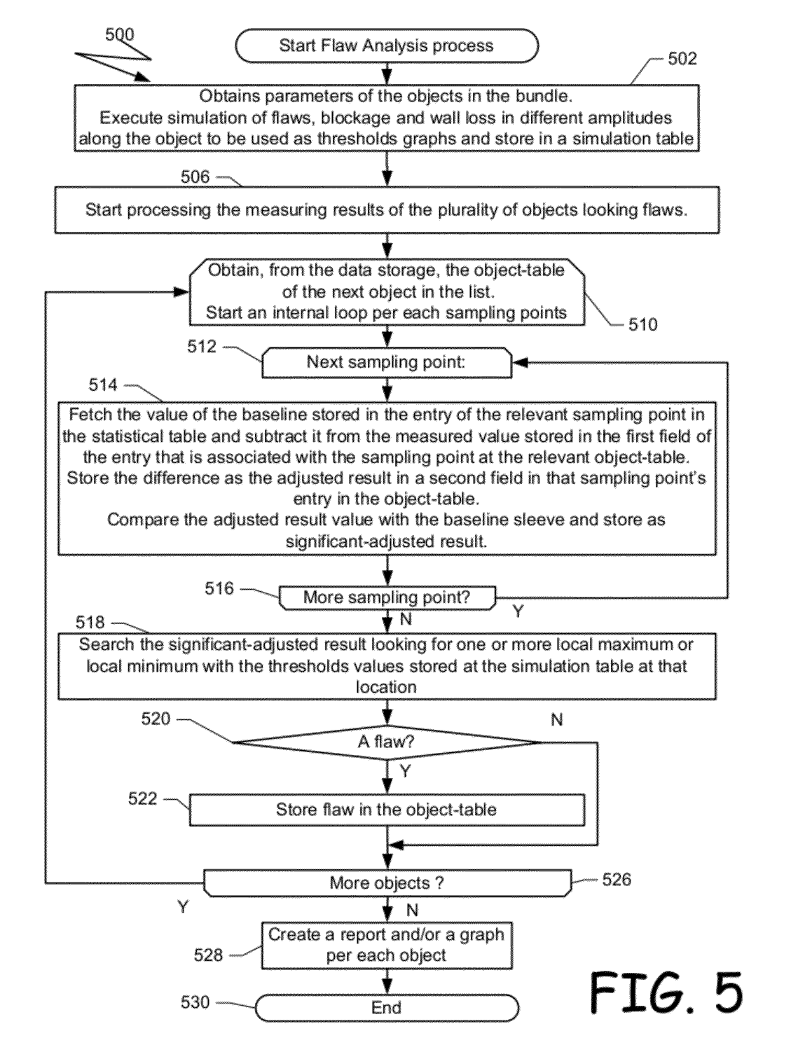

FIG. 5 schematically illustrates a flowchart showing relevant acts of an exemplary embodiment of method 500 for identifying the type and/or the location and/or the size of one or more flaws in a measured elongated hollow object from a plurality of similar elongated hollow objects, according to exemplary teaching of the present disclosure. Method 500 can be implemented by one or more processors of computer 202 (FIG. 2) running instructions stored on a memory device of the computer 202, for example. Method 500 may obtain 502 different parameters regarding the plurality of elongated hollow objects under test. The elongated hollow objects can be devices such as, but not limited to: a bundle of pipes. A few non-limiting examples of the parameters may include: the diameter of the elongated hollow objects, the elongated hollow object's wall width, etc. Method 500 may also obtain 502 parameters on the environment such as, but not limited to: the temperature, the humidity, etc. In some embodiments, the parameters can be obtained at act 402 in FIG. 4.

Method 500 may execute 502 a plurality of simulation processes to simulate expected reflections due to different flaws that may be in the elongated hollow objects under test. Each simulation process can reflect a certain size of a certain type of flaw. Exemplary flaws may include: blockage, wall loss, and so on. A blockage can be represented by a pair of local consecutive extrema, a local maximum, at the beginning of the blockage, followed by local minimum at the end of the blockage. A wall-loss can be represented by a pair of local consecutive extrema, a local minimum, at the beginning of the wall-loss, followed by a local maximum at the end of the wall-loss. The absolute value of the amplitude of the first local extremum of a pair can reflect the size of the flaw. The distance between the two local consecutive extrema points of a pair can reflect the length of the flaw.

The simulated reflection can be location dependent and may have different amplitudes along the length of the elongated hollow object under test. The simulated reflection's amplitudes may be considered as a threshold-value table/graph for estimating the size of a flaw in a certain location along the length of the object, for example. Simulation of reflections due to various types of flaws that may be found in the measured elongated hollow objects, as well as simulation of the interface of the portable probe with an elongated hollow object, can be based on common know-how of APR system as it is described in a plurality of technical articles as the ones that are mentioned above.

In some embodiments, the results of the simulation process can be stored in a simulation table. An exemplary simulation table can have a plurality of entries with each entry being associated with a sampling point. Each entry can comprises a plurality of fields and each field can be associated with a simulated value of a certain flaw and store the amplitude of the simulated refection from that flaw in that sampling point of the first extremum of the pair of extrema of the simulated flaw. In some embodiments, a plurality of threshold curves can be drawn, each curve can be associated with a type and size of a flaw. Exemplary simulation curves are represented in curves 302a-c and 304a-c (FIG. 3C). The curves 302a-c, which are above the Y=C value, (C can be zero, for example) (positive side) can be used for estimating the sizes of blockage and the curves 304a-c, which are below the Y=C value (negatives side), can be used for estimating the sizes of wall-loss, for example. For instance, the curve 302a would represent a flaw that is smaller than the flaws represented by curve 302b.

Method 500 may start 506 a processing loop, between acts 510 and 526, on the plurality of elongated hollow objects under test. For each elongated hollow object, the raw measuring results of the next elongated hollow object may be obtained 510 from the relevant elongated hollow object-table. An internal loop for calculating the adjusted-results of that elongated hollow object for each sampling point may then begin 512. The calculated-ensemble function, the baseline value, at the sampling point may be obtained 514 from the statistical table. An exemplary calculated-ensemble function may be an ensemble average, for example.

The baseline value may be subtracted 514 from the raw measured result at the same sampling point. The difference may be stored 514 at a second field of the relevant entry (sampling point) in the elongated hollow object table as the adjusted result of that sampling point of the elongated hollow object's which measurement are being processed. Then, the absolute value of the adjusted result can be compared with the absolute value of the sleeve at that point. If the adjusted result value is within the sleeve, then it can be referred as a flawless point. If the adjusted results exceed the sleeve, it can be referred as a significant-adjusted result that can reflect a flaw.

Next a decision is made, whether 516 there are more sampling points that need to be analyzed for that elongated hollow object. If 516 there are more sampling points to analyze, then method 500 may return to step 512 and get the next sampling point result to be analyzed. If 524 no additional sampling points need to be analyzed, then method 500 may proceed to act 518.

At step 518 the significant-adjusted results of that elongated hollow object may be searched looking for a pair of local consecutive extrema, a local maximum followed by local minimum, or vice versa. A pair of local maximum followed by local minimum represents a blockage and a pair of local minimum followed by local maximum represents a wall-loss. The value of the first local extremum of each pair is compared to the simulated reflection's threshold-values stored at the different fields in the simulation table in the relevant entry (sampling point), for example. Based on the comparison to the simulation values, a decision needs to be made for each pair of local extrema whether 520 it is a flaw and what is its estimate size (amplitude). If 520 it is not a flaw, then method 500 may proceed to step 526. If 520 it is a flaw, then method 500 may proceed to step 522. At step 522 the detected flaws may be stored 522 at a next field of that entry in that elongated hollow object-table and indicting the flaw type and its estimated size, for example. In some embodiments a sleeve may not be used. In such embodiments, the adjusted result of each point may be compared just with the simulation threshold values of flaws.

At act 526 a decision needs to be made, whether 526 measured results of more elongated hollow objects need to be analyzed. If 526 more results need to be analyzed, then method 500 may return to act 510. If 526 no additional results need to be analyzed, then method 500 may proceed to act 528.

At act 528 method 500 may create a report and/or graph for each elongated hollow object. The report may be a table for each elongated hollow object's ID. The table may include the location of the sampling point and the flaw, for example. The graphs may be such that the X-axis units are the sampling points along the elongated hollow object, and the Y-axis may reflect the size of the flaw, for example. Method 500 may then end. The units that can be used for the X axis can be presented in percentages of the total length of the object and the units of the flaw size can be presented in percentages of the diameter of the hollow object, or percentage of the wall thickness, for example.

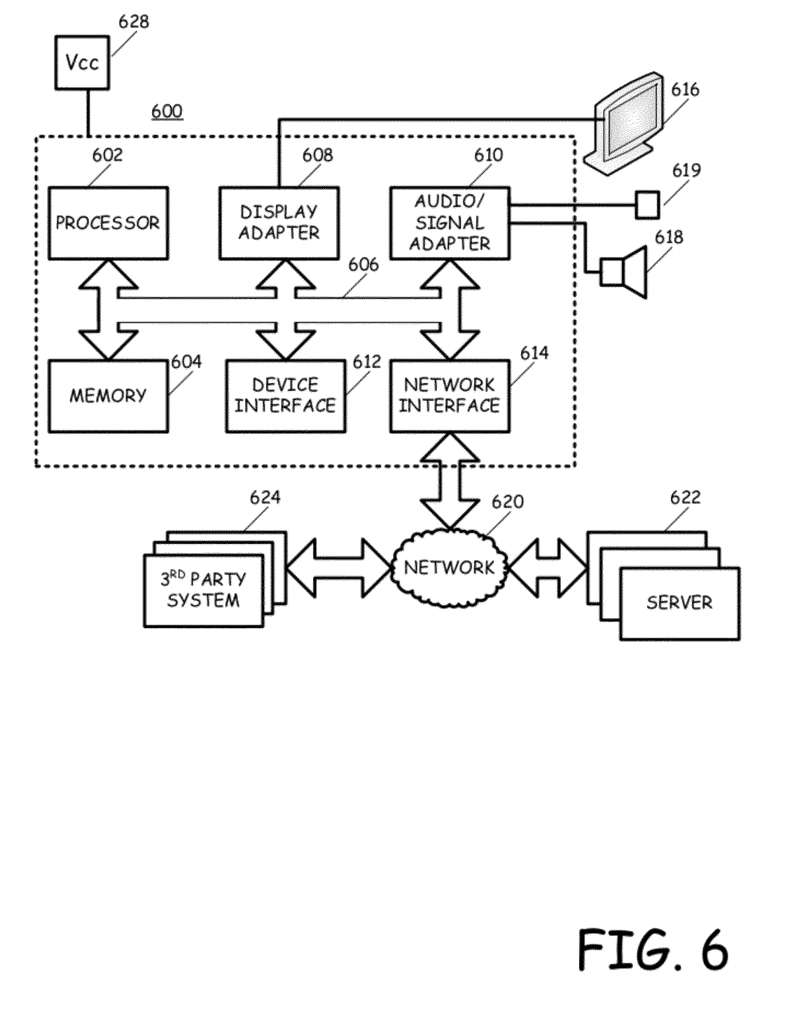

FIG. 6 is a functional block diagram of the components of an exemplary embodiment of a platform that can be used for implementing various embodiments or aspects of various embodiments. It will be appreciated that not all of the components illustrated in FIG. 6 are required in all disclosed embodiments but, each of the components are presented and described in conjunction with FIG. 6 to provide a complete and overall understanding of the components. Further, many specific elements are not presented in FIG. 6 but rather functions and/or functional interfaces are used in a generic fashion to indicate that various embodiments may use a variety of specific components or elements. The measuring system can include a general computing platform 600 illustrated as including a processor 602 and a memory device 604 that may be integrated with each other (such as a microcontroller) or, communicatively connected over a bus or similar interface 606. The processor 602 can be a variety of processor types including microprocessors, micro-controllers, programmable arrays, custom IC's etc. and may also include single or multiple processors with or without accelerators or the like. The memory element of 604 may include a variety of structures, including but not limited to RAM, ROM, magnetic media, optical media, bubble memory, FLASH memory, EPROM, EEPROM, internal or external-associated databases, etc. The processor 604, or other components may also provide components such as a real-time clock, analog to digital converters, digital to analog converters, etc. The processor 602 also interfaces to a variety of elements including a control or device interface 612, a display adapter 608, audio/signal adapter 610 and network/device interface 614. The control or device interface 612 provides an interface to external controls or devices, such as sensor, actuators, transducers or the like. The device interface 612 may also interface to a variety of devices (not shown) such as a keyboard, a mouse, a pin pad, and audio activate device, as well as a variety of the many other available input and output devices or, another computer or processing device. The device interface may also include or incorporate devices such as sensors, controllers, converters, etc. For instance, the amplifier 206, the transmitter 210, and the preamp 204 illustrated in FIG. 2 could all be included in the device interface 612 either as internal or integrated components or, the device interface 612 may interface to the devices as external components. Alternatively the processing unit 202 illustrated in FIG. 2 could interface to the measuring elements as a stand-alone third party system through control lines, a wired network or a wireless network. The display adapter 608 can be used to drive a variety of alert elements and/or display devices, such as display devices including an LED display, LCD display, one or more LEDs or other display devices 616. The audio/signal adapter 610 interfaces to and drives another alert element 618, such as a speaker or speaker system, buzzer, bell, etc. In the various embodiments of the measuring device, the audio/signal adapter 610 could be used to generate the acoustic wave from speaker element 618 and detect the received signals at microphone 619. The amplifiers, digital-to-analog and analog-to-digital converters may be included in the processor 602, the audio/signal adapter 610 or other components within the computing platform 600 or external there to. The network/device interface 614 can also be used to interface the computing platform 600 to other devices through a network 620. The network may be a local network, a wide area network, wireless network, a global network such as the Internet, or any of a variety of other configurations including hybrids, etc. The network/device interface 614 may be a wired interface or a wireless interface. The computing platform 600 is shown as interfacing to a server 622 and a third party system 624 through the network 620. A battery or power source 628 provides power for the computing platform 600.

In the description and claims of the present disclosure, each of the verbs, “comprise”, “include” and “have”, and conjugates thereof, are used to indicate that the elongated hollow object or elongated hollow objects of the verb are not necessarily a complete listing of members, components, elements, or parts of the subject or subjects of the verb.

In this disclosure the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware. Software of a logical module can be embodied on a computer readable medium such as a read/write hard disc, CDROM, Flash memory, ROM, or other memory or storage device. In order to execute a certain task a software program can be loaded to an appropriate processor as needed. In the present disclosure the terms task, method, process can be used interchangeably.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

What is claimed is:

1. A method for estimating parameters of flaws that exist in at least one elongated hollow object (EHO) from a group of a plurality of similar EHOs existing in a bundle of EHOs, the method comprising the acts of:
associating a probe of a Non-Destructive Testing (NDT) system with a first EHO from the group;
measuring the response of the first EHO at a plurality of points along the length of the first EHO to obtain the measured results of the first EHO along the length of the first EHO;
repeating the actions of associating and measuring for each of the remaining plurality of similar EHOs of the group to obtain the measured results along the length of each one of the EHOs within the group;
applying a statistical analysis to the obtained measured results of each one of the EHOs in the group, at each point from the plurality of points along the EHO, in comparison with the obtained measured results of the first of EHO at each respective point from the plurality of points along the first EHO, for defining the adjusted result of the first EHO.

2. The method of claim 1, further comprising repeating the actions of applying and defining for each one of the remaining plurality of EHOs in the group of a plurality of similar EHOs for obtaining the adjusted result for each one of the EHOs of the group.

3. The method of claim 2, further comprising defining a second group of a plurality of similar EHOs from the bundle of EHOs and repeating the actions of claim 1 and 2 on the second group to define the adjusted result of each EHO in the second group.

4. The method of claim 1, wherein the action of applying a statistical analysis further comprises the acts of:
a. calculating an ensemble average of the obtained measured results of each of the plurality EHOs in the group, at each point from the plurality of points along the EHO; and
b. subtracting the calculated ensemble average value, at each point from the plurality of points along the EHO, from the obtained measured result of the first EHO to obtain the adjusted results of the first EHO.

5. The method of claim 1, wherein the action of applying a statistical analysis further comprises the acts of:
subtracting the obtained measured result of each EHO of the group, at each point from the plurality of points along the EHO, from the obtained measured result of the first EHO to obtain a plurality of differences from the measured result of the first EHO;
calculating an ensemble average of the plurality of differences from the measured result of the first EHO, at each point from the plurality of points along the first EHO to obtain the adjusted results of the first EHO.

6. The method of claim 1, wherein the results of the statistical analysis to the obtained measured results is an ensemble median.

7. The method of claim 1, wherein the similar EHO are similar tubes.

8. The method of claim 1, wherein the Non-Destructive Testing system is an Acoustic Pulse Reflectometry system.

9. The method of claim 8, wherein the act of obtaining a measured result from an EHO, wherein the measured result corresponds to sampled values of reflected signal received from the EHO at a plurality of sampling points, further comprises associating the probe to the EHO, and transmitting an acoustic wave into the EHO.

10. The method of claim 1, further comprising searching the adjusted results of the first EHO for one or more pairs of local consecutive extrema points.

11. The method of claim 10, further comprising:
obtaining a plurality of simulation results, at each sampling point along a representative EHO of the plurality of EHO, wherein each simulation corresponds to a reflection signal received from a flaw of a certain size at that sampling point;
comparing, per each found pair of local consecutive extrema points, the adjusted result at the first extremum point of that pair with the simulation results at the sampling point of the first extremum point and determine parameters of a flaw corresponding to the adjusted result and the simulation results; and
reporting the parameters of each one of the determined flaws.

12. The method of claim 11, further comprising repeating the action of claim 11 for each one of the rest of the EHOs in the group.

13. The method of claim 11, wherein the parameters comprise i the type of flaw and the amplitude of the flaw.

14. The method of claim 1, wherein the group of a plurality of similar EHOs comprise 30 or more similar EHOs.

15. The method of claim 2, further comprising:
defining a sleeve along the EHO; and
ignoring each measured result having a value is within the sleeve.

16. The method of claim 1, wherein the flaws are blockages.

17. A non-transitory memory storage device having instructions stored thereon for causing a programmable processor to perform the method of claim 1.

18. An Acoustic Pulse Reflectometry (APR) system, comprising:
a probe comprising a mixed-wave tube coupled with an acoustic-wave transmitter and a microphone, wherein the mixed wave tube is adapted to interface with each pipe from a group of a plurality of similar pipes from a bundle of pipes; and
a processor communicatively coupled with the probe and is configured to: instruct the acoustic-wave transmitter to transmit an acoustic wave toward a pipe from the bundle via the acoustic-wave transmitter; receive a signal that reflects the reflection acoustic wave received from the pipe via the microphone; sample the received signal at a plurality of sampling points wherein each sampling point represents a point along the pipe; store the sampled results in a table associated with that pipe as the measured result of the pipe, continue measuring a next pipe in the bundle until measuring the received signals from all of the plurality of pipes; and
wherein the processor is further configured to: apply a statistical analysis on the obtained measured result of each one of the pipes in the group, at each point from the plurality of points along the pipe, in comparison with the obtained measured results of a first pipe at each respective point from the plurality of points along the first pipe, for defining the adjusted result of the first pipe.

19. The system of claim 18, wherein the statistical analysis is based on an ensemble average of the measured results of the plurality of pipes at each point from the plurality of points along the pipe.

20. The system of claim 18, wherein the processor obtains a plurality of simulation result at each sampling point along a representative pipe of the plurality of pipes, wherein each simulation corresponds to reflection waves received from a flaw having a certain approximate size at the sampling point.

21. The system of claim 18, wherein the processor is further configured to search the adjusted results of each pipe at each sampling point looking for a pair of consecutive extrema points; and, per each found pair of consecutive extrema points, to compare the value of the adjusted result at the first extremum point of that pair with each one of the simulation results at the respective sampling point, of the first extremum point of that pair, and determine whether the adjusted result at that extremum point reflects a flaw corresponding to the simulation result and estimate the flaw size.

22. The system of claim 18, wherein the processor is further configured to report the location and size of each determined flaw along each pipe of the plurality of similar pipes.

23. A non-transitory storage medium readable by a processor and storing instructions for execution by the processor, when executed by the processor, performs a method for estimating parameters of flaws that exist in at least one elongated hollow object (EHO) from a group of a plurality of similar EHOs existing in a bundle of EHOs, the method comprising:
associating a probe of a Non-Destructive Testing (NDT) system with a first EHO from the group;
measuring the response of the first EHO at a plurality of points along the length of the first EHO to obtain the measured results of the first EHO along the length of the first EHO;
repeating the actions of associating and measuring for each of the remaining plurality of similar EHOs of the group to obtain the measured results along the length of each one of the EHOs within the group;
applying a statistical analysis to the obtained measured results of each one of the EHOs in the group, at each point from the plurality of points along the EHO, in comparison with the obtained measured results of the first of EHO at each respective point from the plurality of points along the first EHO, for defining the adjusted result of the first EHO.

24. The non-transitory storage medium of claim 23, further comprising repeating the actions of applying and defining for each one of the remaining plurality of EHOs in the group of a plurality of similar EHOs for obtaining the adjusted result for each one of the EHOs of the group.

25. The non-transitory storage medium of claim 24, further comprising defining a second group of a plurality of similar EHOs from the bundle of EHOs and repeating the actions of claim 23 and 24 on the second group to define the adjusted result of each EHO in the second group.

26. The non-transitory storage medium of claim 23, wherein the action of applying a statistical analysis further comprises the acts:
calculating an ensemble average of the obtained measured results of each of the plurality EHOs in the group, at each point from the plurality of points along the EHO; and
subtracting the calculated ensemble average value, at each point from the plurality of points along the EHO, from the obtained measured result of the first EHO to obtain the adjusted results of the first EHO.

27. The non-transitory storage medium of claim 23, wherein the action of applying a statistical analysis further comprises the acts of:
subtracting the obtained measured result of each EHO of the group, at each point from the plurality of points along the EHO, from the obtained measured result of the first EHO to obtain a plurality of differences from the measured result of the first EHO;
calculating an ensemble average of the plurality of differences from the measured result of the first EHO, at each point from the plurality of points along the first EHO to obtain the adjusted results of the first EHO.

28. The non-transitory storage medium of claim 23, wherein the statistical analysis, at each point from the plurality of points along the EHO of the first EHO, is based on the frequency of appearance of differences of the measured results, compared to the measured results of each one of the other objects in the bundle.
